(19) United States
(12) Patent Application Publication
(10) Pub. No.: US 2011/0229250 A1
(43) Pub. Date: Sep. 22, 2011

(54) Thermally Compensating End Bracket for Mixed Metal Impact Beam

(75) Inventors: Richard M. Kleber, Clarkston, MI (US); John E. Carsley, Clinton Township, MI (US)

(73) Assignee: GM GLOBAL TECHNOLOGY OPERATIONS, INC., Detroit, MI (US)

(21) Appl. No.: 12/726,389

(22) Filed: Mar. 18, 2010

(51) Int. Cl. F16D 1/00

(52) U.S. Cl. 403/29

(57) ABSTRACT

A thermally compensating connection bracket system allows mixed components having dissimilar coefficients of thermal expansion to be connected together at two locations, and yet be able to expand and contract therebetween in response to temperature changes without compromising either of the connections. A bracket carries a boss which passes through an elongated slot of one component and is affixed to the other component such that the first and second components can mutually slide while yet being tightly clamped together.

### TECHNICAL FIELD

The present invention relates to the mutual attachment of mixed metals in which each metal has a different coefficient of thermal expansion, and more particularly to a bracket system for the attaching of mixed metals with thermal compensation.

### BACKGROUND OF THE INVENTION

It is well known that each material has a thermal expansion coefficient which is particular to that material. As per its particular coefficient of thermal expansion, a material will change its dimensions when the temperature changes, given generally by the relation:

ΔX=αXΔT (1)

where X is the original length, ΔT is the change in temperature, α is the coefficient of thermal expansion of the material, and ΔX is the change in length in response to the ΔT.

When mixed materials are mutually superposed, most commonly one material will have a first coefficient of thermal expansion while the other material will have a second, different (usually very different) coefficient of thermal expansion; nonetheless it is possible for mixed materials to have similar, even the same, coefficient of thermal expansion. This thermal aspect of mixed materials may be illustrated by the theory behind the making of reinforced concrete. It is an “accident” of nature that steel/iron has about exactly the same thermal coefficient of expansion as that of concrete (a for steel/iron and concrete is about 12×10⁻⁶ per degree C.), and this is the reason steel or iron rods may be used in the making of reinforced concrete, whereby the steel/iron rods make the concrete much better at load bearing. However, aluminum could not be used for reinforcing concrete, as its coefficient of thermal expansion (α for aluminum is about 25×10⁻⁶ per degree C.) is very different from that of concrete, and over the temperature swings of the seasons, the concrete would be broken by the forces applied to it by the relatively larger amounts of expansion/contraction of aluminum in response to temperature change.

It is seen, therefore, that if mixed materials are mutually connected, it may be necessary to take into account the difference in the coefficients of thermal expansion over a range of temperature to which the mixed materials are expected to experience, particularly if there are two mutually separated connection locations.

An application of interest in this regard is depicted at FIG. 1, wherein a motor vehicle door 10 has an inner panel 12 connected to an outer panel 14, and an impact beam 16 is connected to the inner panel, where the connections 18 may be by welds or bolts. The impact beam 16 is a relatively strong, stiff member which resists bending in the event of a side impact to the relatively more bendable inner and outer door panels 12, 14. If the inner panel 12 of the door 10 and the impact beam 16 are both composed of steel, then there is no need to accommodate dissimilar thermal expansion at the connections 18.

In modern motor vehicles, opportunities to utilize lighter materials are actively pursued, and among these may be the utilization of differing materials which are mixed and mutually connected. And, in that the temperature variation encountered may be more than that experienced by temperature changes due the seasons, as for example if the motor vehicle may be subjected to a heating booth responsive to a painting process, some accommodation of the disparate dimension change due to temperature change is desirable. As a result, if mixed metals are used in a door assembly, it is a common practice to loosely bolt the impact beam to the door panel, perform the painting process with its associated higher than seasonal heat, and then tighten the bolts; however, this practice only allows for accommodation of paint booth expansion and contraction, not that due to seasonal temperature changes, nor allow for the elevated temperatures of a second painting process should the vehicle require that in later life.

Accordingly, what is needed is a way in which mixed materials, be they dissimilar metals or other dissimilar materials, may be mutually connected together at two spaced connection locations, and yet be enabled to remain connected even as each has a mutually differing thermal expansion coefficient.

### SUMMARY OF THE INVENTION

The present invention is a thermally compensating connection bracket system which allows mixed components having dissimilar coefficients of thermal expansion to be connected together at two mutually separated connection locations, and yet be able to expand and contract therebetween at different rates in response to temperature changes without adversely compromising either of the connections.

The thermally compensating connection bracket system according to the present invention provides a thermally compensated connection between two components via at least one junction composed of a junction pad of a first component, a junction slot of a second component and a junction boss of a junction boss bracket.

The junction pad is superposed the junction slot, wherein the junction slot is localized (narrow) along a transverse axis and nonlocalized (elongated) along a longitudinal axis. In this regard, the longitudinal axis is an axis along which the length between two mutually separated connection locations of the first and second components is such that there is a significant disparity between expansion and contraction of the first and second components over a predetermined operational temperature range, per equation (1); wherein the transverse axis is perpendicular to the longitudinal axis.

The junction boss bracket is disposed on a side of the second component which is opposite the first component, wherein the junction boss thereof is localized in both the longitudinal and transverse axes and passes vertically (that is, parallel to a vertical axis perpendicular to the transverse-longitudinal axes plane) through the junction slot of the second component and affixedly abuts the junction pad of the first component. While the junction boss is immovable with respect to the junction pad due to the affixment, it is movable within the junction slot along the longitudinal axis to the extent permitted by the elongation of the junction slot. Accordingly, the second component is enabled to slide relative to the first component along the longitudinal axis. The affixment between the junction boss and the junction pad may be, for example, a weld, a fastener (i.e., a threaded fastener, rivet, etc.) or other fastening modality (i.e., adhesive, etc.).

The thermally compensated connection between the first and second components may be provided by a plurality of relatively closely spaced junctions.

In operation of the thermally compensating bracket connection system of the present invention, expansion or contraction of the first component at a different rate than that of the second component with respect to temperature change is accommodated by the elongation of the junction slot along the longitudinal axis. In this regard, the first and second components will slide relative to each other to the extent permitted by movement of the junction boss within the junction slot, while the affixment clamps tightly the first component to the second component.

Accordingly, it is an object of the present invention to provide a thermally compensating connection bracket system which allows components having dissimilar coefficients of thermal expansion to be connected together and yet be able to expand and contract at different rates responsive to temperature changes without affecting the connection therebetween.

This and additional objects, features and advantages of the present invention will become clearer from the following specification of a preferred embodiment.

### BRIEF DESCRIPTION OF THE DRAWINGS

FIG. 1 is a broken away side view of a motor vehicle door having a conventional impact beam attached to the inside panel thereof.

FIG. 2 is a broken away, exploded perspective view, showing the thermally compensating bracket connection system according to the present invention for connecting together first and second components.

FIG. 2A is a side view of a junction boss bracket, which is also shown in perspective in FIG. 2.

FIG. 3A is a broken away, perspective view, showing the thermally compensating bracket connection system of FIG. 2 in operation at a first connection location whereby the first and second components are now shown connected, wherein additionally shown is an optionally conventional second connection location.

FIG. 3B is a broken away, perspective view, showing the thermally compensating bracket connection system of FIG. 2, now shown in operation connecting first and second components at both the first and second connection locations.

FIG. 4 is a broken away sectional view, shown along line 4-4 of FIG. 3A.

FIG. 5 is a broken away sectional view, shown along line 5-5 of FIG. 3A.

FIG. 6A is an example of operation of the thermally compensating bracket connection system seen as in FIG. 4, wherein now the second component has a lower thermal expansion coefficient and the temperature has decreased.

FIG. 6B is an example of operation of the thermally compensating bracket connection system seen as in FIG. 4, wherein now the second component has a lower thermal expansion coefficient and the temperature has increased.

FIG. 7A is a broken away, perspective view, showing the thermally compensating bracket connection system similar to FIG. 2, but now utilizing threaded fasteners rather than welds to provide the connection between the first and second components.

FIG. 7B is a broken away sectional view, shown along line 7B-7B of FIG. 7A.

FIG. 8 is a broken away, perspective view, showing the thermally compensating bracket connection system similar to FIG. 7A, wherein now the junction boss bracket is flexibly connected to an end of the second component.

### DESCRIPTION OF THE PREFERRED EMBODIMENT

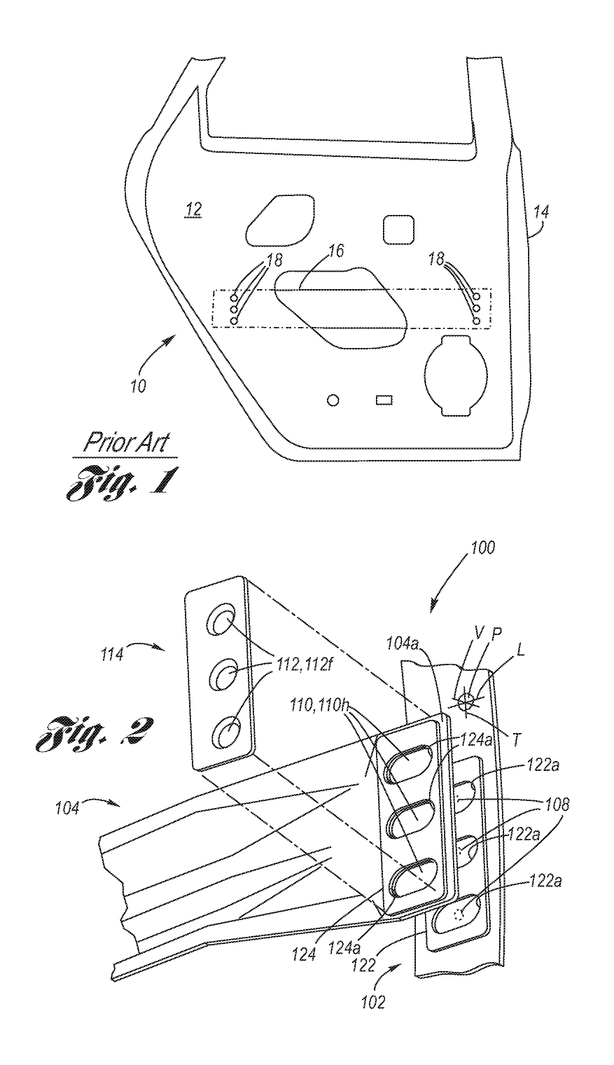

Referring now to the Drawings, FIGS. 2 through 8 depict examples of a thermally compensating bracket connection system 100 according to the present invention. While the thermally compensating bracket connection system 100 may be advantageously used in a motor vehicle door and impact beam connection modality in the sense of use depicted at FIG. 1, it is to be understood that the present invention pertains to the connection of any first and second components having disparate thermal expansion coefficients, wherein the first and second components may be of materials other than both being metals, as for example metal and non-metal (i.e., aluminum and a carbon composite) or non-metal and non-metal (i.e., a carbon composite and plastic).

Turning attention firstly to FIGS. 2 through 6B a first preferred form of the thermally compensating bracket connection system 100 is depicted for mutually connecting together a first component 102 and a second component 104, wherein the first and second components are exemplified (merely for illustration purposes) as a motor vehicle door panel and impact beam, respectively.

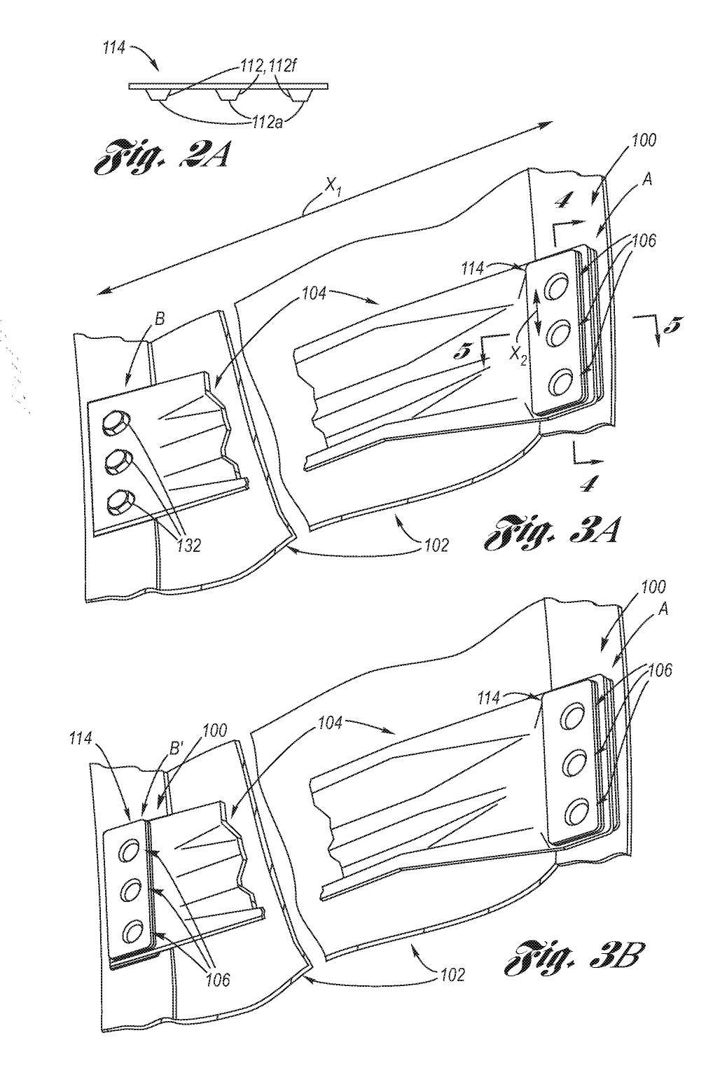

As a preliminary to the discussion, a directional convention is defined by longitudinal, transverse and vertical axes L, T and V depicted at FIG. 2. The longitudinal axis L is defined as the axis along which the length of separation between two connection locations (see distance X₁ between first connection location A and second connection location B at FIG. 3) of the first and second components 102, 104 is such that there is a significant disparity between expansion and contraction therebetween over a predetermined operational temperature range, as per equation (1). The transverse axis T is perpendicular to the longitudinal axis L. The vertical axis V is oriented perpendicular to a plane P defined by the transverse and longitudinal axes T, L.

The first connection location A is provided by the thermally compensating connection bracket system 100, wherein the first component 102 is connected to the second component 104 via at least one junction 106, three being shown by way of exemplification. Each junction 106 includes a junction pad 108 of the first component 102, a junction slot 110 of the second component, and a junction boss 112 of a junction boss bracket 114. In order that multiple junctions be unaffected by temperature change, per equation (1), the spacing therebetween must be sufficiently small that that the changes in length over that small spacing can be ignored. This is exemplified at FIG. 3A, where X₂ between junctions 106 is very small (as for example compared to X₁).

The second component 104 is disposed between the junction boss bracket 114 and the first component 102. The junction pad 108 is superposed the junction slot 110, wherein the junction slot is nonlocalized (elongated) along the longitudinal axis L in the sense that it has a first cross-section elongated therealong, and is localized (narrow) along the transverse axis T in the sense it has a second cross-section along the transverse axis T smaller that the first cross-section. The junction boss bracket 114 carries the junction boss 112 for each junction 106, respectively. Each junction boss 112 is localized in both the longitudinal and transverse axes L, T and passes vertically (that is, along the vertical axis V perpendicular to the transverse-longitudinal axes plane P) through the junction slot 110 of the second component 104 and affixedly abuts the junction pad 108 of the first component 102, whereby each junction pad is immovable with respect to its junction boss.

The first and second components 102, 104 are able to slide relative to one another based upon the freedom of movement of the junction boss 112 in the junction slot 110. In this respect, since the first cross-section of the junction slot 110 is nonlocal (elongated) along the longitudinal axis L relative movement is allowed for expansion and contraction differentials of the first and second components over a predetermined temperature range, as per equation (1). At the same time, since the second cross-section of the junction slot 110 is constant and local along the transverse axis T, the junction boss 112 guidingly abuts the junction slot along a parallel to the longitudinal axis as it moves in response to expansion and contraction differentials of the first and second components over a predetermined temperature range, as per equation (1).

As shown by way of exemplification in FIGS. 2 through 6B, each junction slot 110 is preferably in the form of an elongated hole 110h formed in the second component, having its first cross-section (elongation) C1 parallel to the longitudinal axis L and having its second cross-section C2 parallel to the transverse axis; each junction boss 112 is preferably in the form of a vertically depending frustoconical flange 112f of the junction boss bracket 114 which is sized to pass through the junction slot 110 of the second component 104 and generally abut the slot wall 110w thereof at the second cross-section along a parallel to the longitudinal axis L; and each junction pad 108 is a surface of the first component 102 which superposes the junction slot 110 and upon which is abuttingly affixed a flat 112a of the flange 112f.

The affixment modality between the junction boss bracket 114 and the first component 102 is shown by way of example in the form of a weld 130 between the junction boss 110 (at each flat 112a of the respective flanges 112f) and the junction pad 108 of the first component 102. In this regard, the choice of material for the junction boss bracket 114 is based upon ease of weld with respect to the material of the first component 102. For example, if the first component 102 is aluminum, then for purposes of making the welds 130, the junction boss bracket 114 is similarly made of aluminum. Other affixment modalities may be used, as mentioned hereinbelow.

Advantageously included are first and second gaskets 122, 124, which may, for example, be composed of an elastomer or a polymer. The first gasket 122 is disposed between the first and second components 102, 104, and the second gasket 124 is disposed between the second component 104 and the junction boss bracket 114. An elongated gasket hole 122a, 124a is provided in the first and second gaskets 122, 124, one gasket hole for each junction 106, respectively, wherein each gasket hole is sized to be at least as large as each junction slot 110 (elongated hole 110h) of the second component 102 such that each junction boss 112 (flange 112f) passes therethrough and is operatively movable therein in response to differential length changes of the first and second components. The purpose of the first and second gaskets 122, 124 is to minimize vibration and rattling as between the first and second components 102, 104 and provide a slippage medium as between the second component with respect to both the junction boss bracket 114 and the first component. An adhesive can be applied to one side of the first and second gaskets in order to locate them immovably to one of the junction boss bracket, the first component or the second component, as the case may be.

Operation of the thermally compensating bracket connection system 100 is depicted at FIGS. 6A and 6B, wherein by way of exemplification the first component 102 is aluminum (as is the junction boss bracket 114) and the second component 104 is steel. By analogy to FIG. 1 and as depicted by exemplification at FIG. 3, the first component 102 is an inner door panel and the second component 104 is an impact beam. In this regard, FIG. 3A depicts operation in which the first connection location A utilizes the thermally compensating bracket connection system 100, and the second connection location B uses fasteners 132; whereas FIG. 3B depicts operation in which the first connection location A and the second connection location B′ utilize the thermally compensating bracket connection system 100.

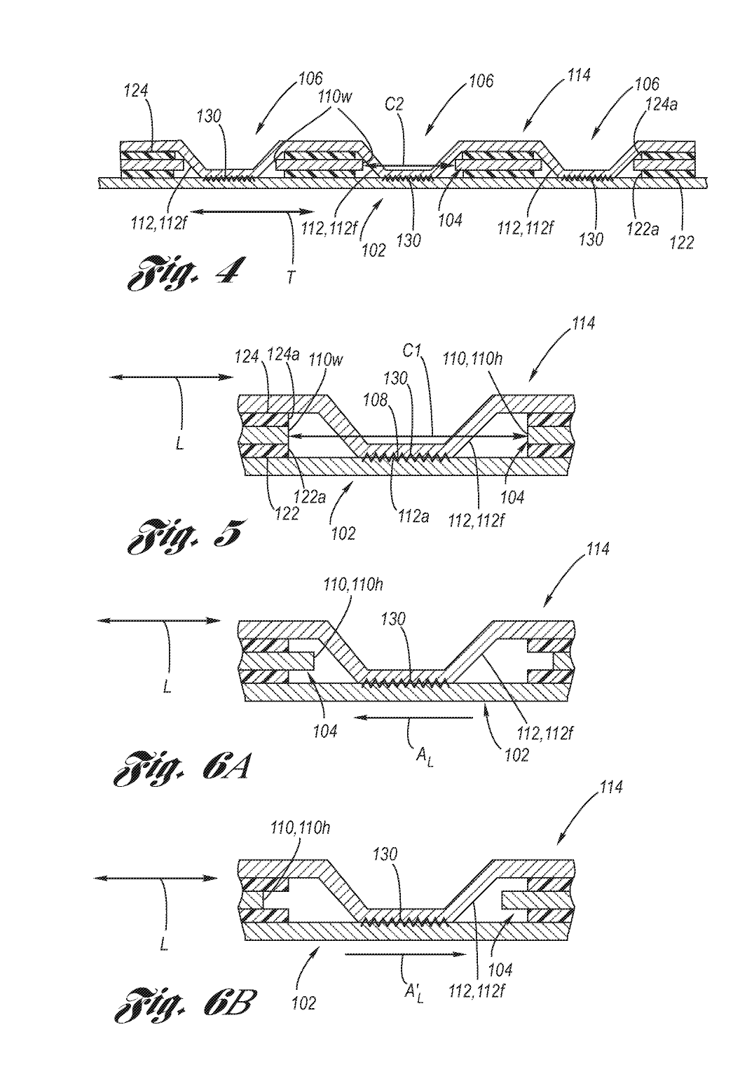

FIG. 6A shows what happens when the temperature decreases from the temperature extant at FIG. 5, wherein since the first component 102 is aluminum, it will contract relatively more than the second component 104, which is steel. Since the junction boss bracket 114 is immovably affixed to the first component 102, it remains stationary with respect thereto, as does its junction boss 112. The differential in length change as between the first and second components 102, 104 is accommodated by slippage between the first and second components in which the junction boss 112 is free to move within the junction slot 110 (or elongated hole 110h) parallel to the longitudinal axis L. Arrow A_{L} represents the relatively greater contraction by the aluminum.

FIG. 6B shows what happens when the temperature increases from the temperature extant at FIG. 5, wherein the first component 102, being aluminum, will expand relatively more than the second component 104, which is steel. The differential in length change as between the first and second components 102, 104 is accommodated by slippage between the first and second components in which the junction boss 112 is free to move within the junction slot 110 parallel to the longitudinal axis L. Arrow A_{L}′ represents the relatively greater expansion by the aluminum.

In the examples, the junction boss 112 will guidingly abut the portion of the slot wall 110w which is parallel to the longitudinal axis L as the first component changes length relative to the second component 102, 104, thereby providing fixed location of the first and second components with respect to the transverse axis T.

It will be understood that the length of the first cross-section of the junction slots 110 (elongated holes 110h) is sized to accommodate the differential in length as between the mixed metals at the connection location due to expansion and contraction over a predetermined range of temperature, as per freedom of movement of the junction boss 112 therewithin. For example, the junction boss 112 (the flat 112a of the flange 112f) could be affixed at a medial disposition of the junction boss, as for example depicted at FIG. 5, for a medial temperature between expected temperature extremes of the expected temperature range. By way of example the extremes may be envisaged at FIGS. 6A and 6B, wherein the first cross-section is over-sized in case the expected extremes are exceeded in operation (i.e., a painting process).

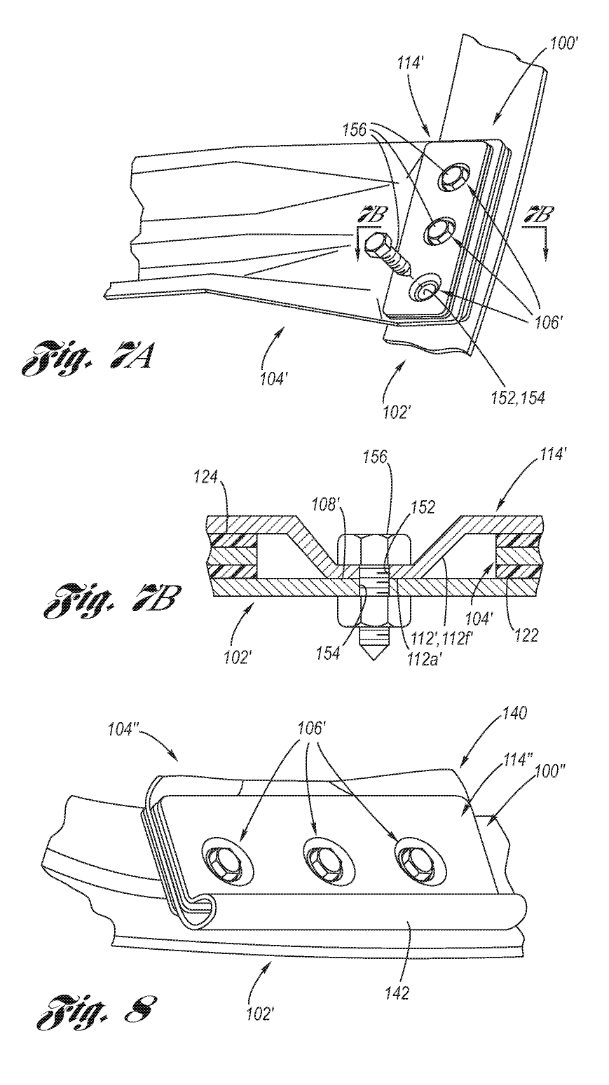

FIGS. 7A and 7B illustrate an example of an alternative fastening modality for the thermally compensating bracket connection system 100′, wherein other fastening modalities (i.e., rivet, adhesive, etc.) may be used to provide the affixment of the junction boss to the junction pad.

In this illustration, the junction boss 112′ is in the form of a vertically depending frustoconical flange 112f′ of the junction boss bracket 114′ but now having a flange hole 152 formed in the flat 112a′. Each of the junctions 106′ further include a first component hole 154 which is superposed the flange hole 152. A threaded fastener 156 passes through the flange hole 152, the elongated hole 110h and the first component hole 154, and is threadably tightened thereat. In operation, the thermally induced differential in expansion and contraction as between the first and second components is accommodated as described with respect to FIGS. 6A and 6B.

The use of a fastener is preferred over a weld in situations, as mentioned above, a weld would be difficult. For example if the first component is aluminum and the junction boss bracket is steel, then welding would be difficult and a fastener (threaded fastener, rivet, etc.) would be a preferred affixment modality.

FIG. 8 depicts a thermally compensating bracket connection system 100″, with the variation being that the junction boss bracket 114″ is flexibly connected to the end of the second component 104″. In this regard, the second component 104″ and the junction boss bracket 114″ are constructed of a single piece 140, wherein they are then foldably manipulated so that a flexible loop 142 is formed therebetween. In the event the first component 102′ is aluminum and the single piece 140 is steel, then fasteners, as in FIGS. 7A and 7B, are a preferred affixment modality.

During differential thermal expansion and contraction as between the first and second components 102′, 104″ as temperature changes, the movement of the second component relative to the junction boss bracket 114″ (which must always be stationary with respect to the first component 102′ due to its affixment thereto), is accommodated by distortion of the loop 142. The loop 142 can be weakened to provide better flexibility, as for example by scoring or slotting.

To those skilled in the art to which this invention appertains, the above described preferred embodiment may be subject to change or modification. Such change or modification can be carried out without departing from the scope of the invention, which is intended to be limited only by the scope of the appended claims.

1. A thermally compensated bracket attachment system, comprising:
a first component;
a junction boss bracket;
a second component disposed between said first component and said junction boss bracket; and
a connection between said first and second components, said connection comprising at least one junction, each said junction comprising:
a junction boss connected with said junction boss bracket;
a junction pad of said first component;
a junction slot of said second component, said junction slot being elongated along a longitudinal axis; and
an affixment immovably affixing said junction boss to said junction pad such that at said connection said first component is tightly clamped with respect to said second component;
wherein said junction pad and said junction slot are mutually superposed, and wherein said junction boss passes through said junction slot and abuts said junction pad such that said junction boss is slidable within said junction slot along the longitudinal axis.

2. The attachment system of claim 1, wherein said connection comprises a plurality of said junctions.

3. The attachment system of claim 1, wherein said junction slot comprises a slot wall having an elongated first cross-section parallel to the longitudinal axis and a second cross-section perpendicular to the longitudinal axis, said second cross-section being smaller than said first cross-section.

4. The attachment system of claim 3, wherein said junction boss generally abuts the slot wall disposed in parallel relation to said longitudinal axis at the second cross-section.

5. The attachment system of claim 4, wherein said connection comprises a plurality of said junctions.

6. The attachment system of claim 4, wherein said affixment comprises a weld between said junction boss and said junction pad.

7. The attachment system of claim 4, wherein said affixment comprises:
said junction boss and said junction pad each having formed respectively therein a hole; and
a fastener passing through the holes in said junction boss and said junction pad such that said fastener tightly clamps said junction boss to said junction pad.

8. The attachment system of claim 4, said connection further comprising:
a first gasket disposed between said first component and said second component; and
a second gasket disposed between said junction location bracket and said second component;
wherein at each said junction said first and second gaskets each have formed therein a hole through which said junction boss passes.

9. The attachment system of claim 4, wherein said junction boss bracket is connected to an end of said second component by a flexible loop integrally connected to both said junction boss bracket and said second component.

10. The attachment system of claim 9, wherein said connection comprises a plurality of said junctions.

11. A thermally compensated bracket attachment system, comprising:
a first component having a first coefficient of thermal expansion;
a junction boss bracket;
a second component disposed between said first component and said junction boss bracket, said second component having a second coefficient of thermal expansion, said first and second coefficients of thermal expansion being mutually different;
a first connection between said first and second components, said first connection comprising at least one junction, each said junction comprising:
a junction boss connected with said junction boss bracket;
a junction pad of said first component;
a junction slot of said second component, said junction slot being elongated along a longitudinal axis; and
an affixment immovably affixing said junction boss to said junction pad such that at said connection said first component is tightly clamped with respect to said second component;
wherein said junction pad and said junction slot are mutually superposed, and wherein said junction boss passes through said junction slot and abuts said junction pad such that said junction boss is slidable within said junction slot along the longitudinal axis; and
a second connection between said first and second components, said first and second connections being mutually separated along a line parallel to said longitudinal axis;
wherein the sliding of said junction boss within said junction slot is in response to a differential length change of said first and second components as a result of a mutual temperature change of the first and second components.

12. The attachment system of claim 11, wherein said connection comprises a plurality of said junctions.

13. The attachment system of claim 11, wherein said junction slot comprises a slot wall having an elongated first cross-section parallel to the longitudinal axis and a second cross-section perpendicular to the longitudinal axis, said second cross-section being smaller than said first cross-section.

14. The attachment system of claim 13, wherein said junction boss generally abuts the slot wall disposed in parallel relation to said longitudinal axis at the second cross-section.

15. The attachment system of claim 14, wherein said connection comprises a plurality of said junctions.

16. The attachment system of claim 14, wherein said affixment comprises a weld between junction boss and said junction pad.

17. The attachment system of claim 14, wherein said affixment comprises:
said junction boss and said junction pad each having formed respectively therein a hole; and
a fastener passing through the holes in said junction boss and said junction pad such that said fastener tightly clamps said flat to said junction pad.

18. The attachment system of claim 14, said connection further comprising:
a first gasket disposed between said first component and said second component; and
a second gasket disposed between said junction location bracket and said second component;
wherein at each said junction said first and second gaskets each having formed therein a hole through which said junction boss passes.

19. The attachment system of claim 14, wherein said junction boss bracket is connected to an end of said second component by a flexible loop integrally connected to said junction boss bracket and said second component.

20. The attachment system of claim 14, wherein said second connection comprises at least one said junction.
